(19) United States
(12) Patent Application Publication
(10) Pub. No.: US 2022/0276809 A1
(43) Pub. Date: Sep. 1, 2022

(54) INTERFACE BETWEEN CONTROL PLANES

(71) Applicant: Intel Corporation, Santa Clara, CA (US)

(72) Inventors: Keren GUY, Sunnyvale, CA (US); Anjali Singhai JAIN, Portland, OR (US); Neerav PARIKH, Hillsboro, OR (US); Kirill KAZATSKER, Ramat Gan (IL); Arunkumar BALAKRISHNAN, Santa Clara, CA (US); Jayaprakash SHANMUGAM, Portland, OR (US); Hieu TRAN, Portland, OR (US)

(21) Appl. No.: 17/747,955

(22) Filed: May 18, 2022

Related U.S. Application Data
(63) Continuation-in-part of application No. 17/670,355, filed on Feb. 11, 2022.

(51) Int. Cl. G06F 3/06

(52) U.S. Cl. CPC G06F 3/0659; G06F 3/0635; G06F 3/0622; G06F 3/067; G06F 3/0679

(57) ABSTRACT

Examples described herein relate to a packet processing device. In some examples, the packet processing device includes multiple processors and data plane circuitry. In some examples, a first processor of the multiple processors is to perform a first control plane, a second processor of the multiple processors is to perform a second control plane, and the first and second control planes are to communicate through an interface and wherein the first control plane is to discover capabilities of data plane circuitry and configure operation of the data plane circuitry by the interface.

### RELATED APPLICATION

The present application is a continuation-in-part of U.S. patent application Ser. No. 17/670,355, filed Feb. 11, 2022 (Attorney Docket Number AD9072-US). The contents of that application are incorporated herein in their entirety.

### BACKGROUND

In a datacenter, some network interface devices include programmable data planes that are configurable by a control plane. The control plane can configure the programmable data planes with certain rules of operation so that the network interface device can independently perform packet processing operations.

### BRIEF DESCRIPTION OF THE DRAWINGS

FIG. 1 depicts an example system.

FIG. 2 depicts an example system.

FIGS. 3A-3D depict example sequences.

FIG. 4 depicts an example process.

FIG. 5 depicts an example network interface device.

FIG. 6 depicts an example packet processing device.

FIG. 7 depicts an example system.

FIG. 8 depicts an example system.

### DETAILED DESCRIPTION

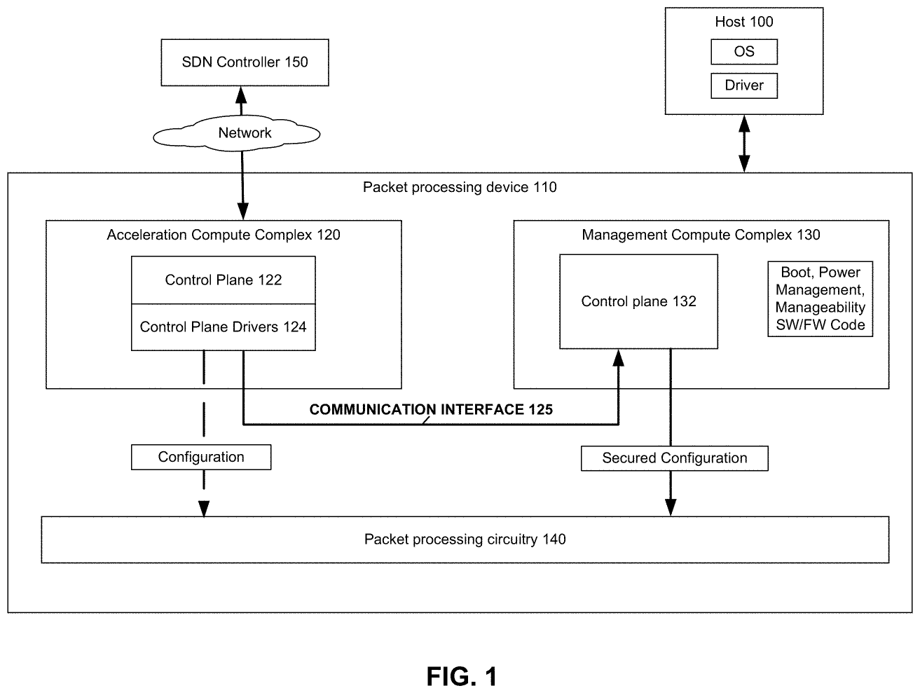

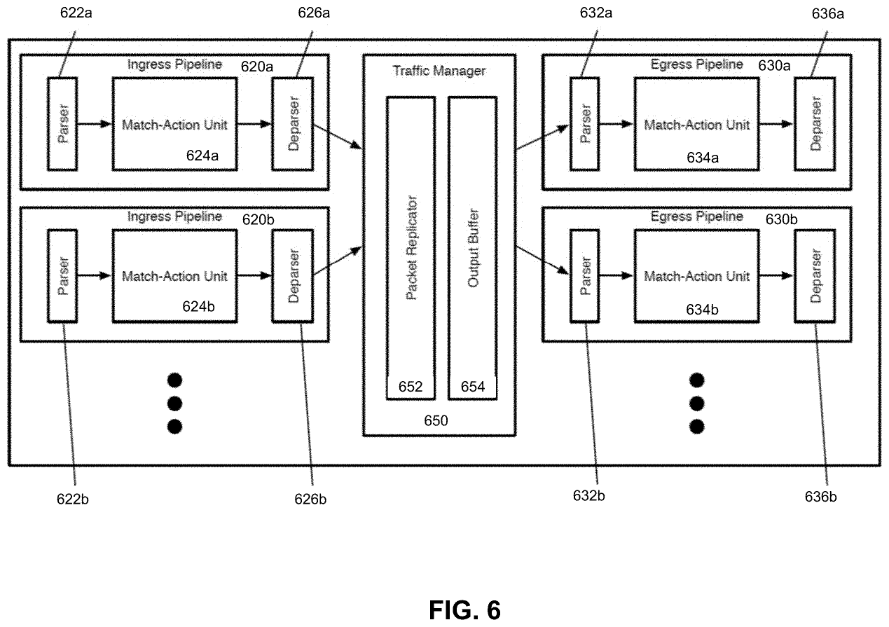

FIG. 1 depicts an example system. Host 100 can include processors, memory devices, device interfaces, as well as other circuitry such as described with respect to FIG. 6. Processors of host 100 can execute software such as applications (e.g., microservices, virtual machine (VMs), microVMs, containers, processes, threads, or other virtualized execution environments), operating system (OS), and device drivers. An OS or device driver can configure packet processing device 110 to utilize one or more control planes to communicate with software defined networking (SDN) controller 150 via a network to configure operation of the one or more control planes.

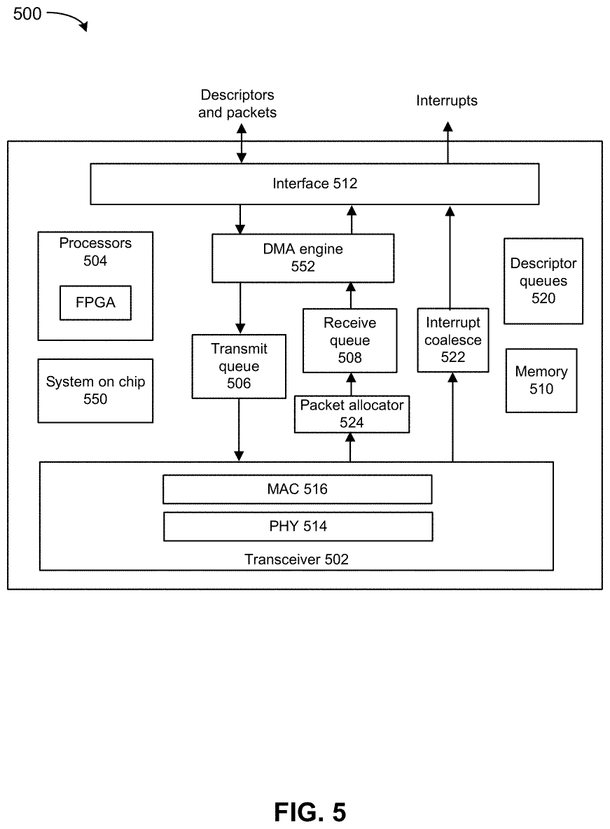

Packet processing device or data plane circuitry 110 can include multiple compute complexes, such as an Acceleration Compute Complex (ACC) 122 and Management Compute Complex (MCC) 130, as well as packet processing circuitry 140 and network interface technologies for communication with other devices via a network. ACC 120 can be implemented as one or more of: a microprocessor, processor, accelerator, field programmable gate array (FPGA), application specific integrated circuit (ASIC) or circuitry described at least with respect to FIGS. 5-8. Similarly, MCC 130 can be implemented as one or more of: a microprocessor, processor, accelerator, field programmable gate array (FPGA), application specific integrated circuit (ASIC) or circuitry described at least with respect to FIGS. 5-8. In some examples, ACC 120 and MCC 130 can be implemented as separate cores in a CPU, different cores in different CPUs, different processors in a same integrated circuit, different processors in different integrated circuit.

Packet processing device 110 can be implemented as one or more of: a microprocessor, processor, accelerator, field programmable gate array (FPGA), application specific integrated circuit (ASIC) or circuitry described at least with respect to FIGS. 5-8. Packet processing pipeline circuitry 140 can process packets as directed or configured by one or more control planes executed by multiple compute complexes. In some examples, ACC 120 and MCC 130 can execute respective control planes 122 and 132.

SDN controller 150 can upgrade or reconfigure software executing on ACC 120 through contents of packets received through packet processing device 110. In some examples, ACC 120 can execute control plane operating system (OS) (e.g., Linux) and/or a control plane application 122 (e.g., user space or kernel modules) used by SDN controller 150 to configure operation of packet processing pipeline 140. Control plane application 122 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 150 can communicate with ACC 120 using a remote procedure call (RPC) such as Google remote procedure call (gRPC) or other service and ACC 120 can convert the request to target specific protocol buffer (protobuf) request to MCC 130. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 150 can provide rules for application by ACC 120. For example, ACC 120 can program table rules (e.g., header field match and corresponding action) applied by packet processing pipeline circuitry 140 based on change in policy and changes in VMs, containers, microservices, applications, or other processes. ACC 120 can be configured to provide network policy as flow cache rules into a table to configure operation of packet processing pipeline 140. For example, the ACC-executed control plane application 122 can configure rule tables applied by packet processing pipeline circuitry 140 with rules to define a traffic destination based on packet type and content. ACC 120 can program table rules (e.g., match-action) into memory accessible to packet processing pipeline circuitry 140 based on change in policy and changes in VMs.

A flow can be a sequence of packets being transferred between two endpoints, generally representing a single session using a protocol. Accordingly, a flow can be identified, using a match, by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

For example, ACC 120 can execute a virtual switch such as vSwitch or Open vSwitch (OVS), Stratum, or Vector Packet Processing (VPP) that provides communications between virtual machines executed by host 200 or with other devices connected to a network. For example, ACC 120 can configure packet processing pipeline circuitry 140 as to which VM is to receive traffic and what kind of traffic a VM can transmit. For example, packet processing pipeline circuitry 140 can execute a virtual switch such as vSwitch or Open vSwitch that provides communications between virtual machines executed by host 100 and packet processing device 110.

MCC 130 can execute a host management control plane, global resource manager, and perform hardware registers configuration. Control plane 132 executed by MCC 130 can perform provisioning and configuration of packet processing circuitry 140. For example, a VM executing on host 100 can utilize packet processing device 110 to receive or transmit packet traffic. MCC 130 can execute boot, power, management, and manageability software (SW) or firmware (FW) code to boot and initialize the packet processing device 110, manage the device power consumption, provide connectivity to Baseboard Management Controller (BMC), and other operations.

One or both control planes of ACC 120 and MCC 130 can define traffic routing table content and network topology applied by packet processing circuitry 140 to select a path of a packet in a network to a next hop or to a destination network-connected device. For example, a VM executing on host 100 can utilize packet processing device 110 to receive or transmit packet traffic. Configuration of packet processing device 110 resources exclusively associated with control plane 122 can be configured through the unsecure configuration path. Configuration of resources shared between control plane 122 and control plane 132 can be configured through a secure configuration. Secure configuration also configures resources used exclusively by the VM, so the VM resources can be accessed only by the designated VM.

ACC 120 can execute control plane drivers to communicate with MCC 130. At least to provide a configuration and provisioning interface between control planes 122 and 132, communication interface 125 can provide control-plane-to-control plane communications. Control plane 132 can perform a gatekeeper operation for configuration of shared resources. For example, via communication interface 125, ACC control plane 122 can communicate with control plane 132 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 125 can be utilized by a negotiation protocol and configuration protocol running between ACC control plane 122 and MCC control plane 132. Communication interface 125 can include a general purpose mailbox for different operations performed by packet processing circuitry 140. Examples of operations of packet processing circuitry 140 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 125 can include one or more mailboxes accessible as registers or memory addresses. For communications from control plane 122 to control plane 132, communications can be written to the one or more mailboxes by control plane drivers 124. For communications from control plane 132 to control plane 122, communications can be written to the one or more mailboxes.

Communication interface 125 can provide communications based on writes or reads to particular memory addresses (e.g., dynamic random access memory (DRAM)), registers, other mailbox that is written-to and read-from to pass commands and data. To provide for secure communications between control planes 122 and 132, registers and memory addresses (and memory address translations) for communications can be available only to be written to or read from by control planes 122 and 132 or cloud service provider (CSP) software executing on ACC 120 and device vendor software or firmware executing on MCC 130. In some examples, communications (e.g., messages, descriptors, and/or data communicated) between ACC 120 and MCC 130 can be encrypted whereby a sender can encrypt the communications and the receiver can decrypt the received communications based on a key.

Communication interface 125 can support communications between multiple different compute complexes such as from host 100 to MCC 130, host 100 to ACC 120, MCC 130 to ACC 120, baseboard management controller (BMC) to MCC 130, BMC to ACC 120, or BMC to host 100. Communication interface 125 can permit scaling up and/or down a number of devices or processes that are able to be configured when accelerator or compute complexes are added or removed. Communication interface 125 can support communications with more than two control planes (e.g., three or more) such as control planes executing on packet processing device 110 and/or host 100.

Communication interface 125 can transfer remote procedure call (RPC) protocol buffers (protobufs) for making direct application program interface (API) calls from one complex to another (e.g., ACC 120 to MCC 130, MCC 130 to ACC 120, SDN controller 150 to ACC 120 or MCC 130, or host 100 to ACC 120 or MCC 130). A same channel can be used for subscribing to events coming from the device to the control plane application.

Communications written to mailboxes can include descriptors which include message opcode, message error, message parameters, and other information. Communications written to mailboxes can include defined format messages that convey data. For example, the following Tables 1-3 provide examples of descriptor format.

TABLE 1

| +3 | | | | | | | | +2 | | | | | | | | +1 | | | | | | | | +0 | | | | | | | |
|---|---|---|---|---|---|---|---|---|---|---|---|---|---|---|---|---|---|---|---|---|---|---|---|---|---|---|---|---|---|---|---|
| 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 |

| | |
|---|---|
| Message Infrastructure Type | Reserve |
| Control Plane Identification | Message Data Length |
| Message Return Error | Message Opcode |

Cookie
Message Parameter 0
Message Parameter 1
Data Address High/Message Parameter 2
Data Address Low/Message Parameter 3

TABLE 2
Transmit (Tx) Descriptor Fields

| Name | Bytes | Description |
|---|---|---|
| Reserve | 0-1 | Reserve. Can be set to zero. |
| Message Infrastructure | 2-3 | Identifies the message type such as |
| Type | | secure or non-secure. |
| Message Data Length | 4-5 | Data buffer message length in bytes. |
| Control Plane | 6-7 | Identifies the sending control plane. |
| Identification | | |
| Message Opcode | 8-9 | Cpchnl Message opcode identified |
| | | the content of the message. |
| Message Return Value | 10-11 | Zero for sending message. |
| | | Return Value for the message return. |
| Cookie | 12-15 | Used for cookie to be delivered to |
| | | the receiver. |
| Message Parameter 0 | 16-19 | Can be used to include message |
| | | parameter. |
| Message Parameter 1 | 20-23 | Can be used to include message |
| | | parameter. |
| Data Address | 24-27 | When “Message Data Length” field |
| High/Message | | is not zero, contains the data buffer |
| Parameter 2 | | address. Otherwise, can be used to |
| | | include message parameter. |
| Data Address | 28-31 | When “Message Data Length” field |
| Low/Message | | is not zero, contains the data buffer |
| Parameter 3 | | address. Otherwise, can be used to |
| | | include message parameter. |

TABLE 3
Receive (Rx) Descriptor Fields

| Name | Bytes | Description |
|---|---|---|
| Reserve | 0-1 | Reserve. Shall be set to zero. |
| Message Infrastructure | 2-3 | Identifies the message type such as |
| Type | | secure or non-secure. |
| Message Data Length | 4-5 | Data buffer message length in bytes. |
| Control Plane | 6-7 | Identifies the sending control plane. |
| Identification | | |
| Message Opcode | 8-9 | Preserve the field value from the |
| | | Tx descriptor. |
| Message Return Value | 10-11 | Return Value for the message return. |
| | | 0 - success, other - error type |
| Cookie | 12-15 | Preserve the field value from the |
| | | Tx descriptor. |
| Message Parameter 0 | 16-19 | Preserve the field value from the |
| | | Tx descriptor. |
| Message Parameter 1 | 20-23 | Preserve the field value from the |
| | | Tx descriptor. |
| Data Address | 24-27 | Preserve the field value from the |
| High/Message | | Tx descriptor. |
| Parameter 2 | | |
| Data Address | 28-31 | Preserve the field value from the |
| Low/Message | | Tx descriptor. |
| Parameter 3 | | |

Packet processing circuitry 140 can be implemented using one or more of: application specific integrated circuit (ASIC), field programmable gate array (FPGA), processors executing software, or other circuitry. Various examples of packet processing pipeline circuitry 140 are described herein. Control plane 122 and/or 132 can configure packet processing pipeline circuitry 140 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 120 or MCC 130. In some examples, a P4 program can be compiled and provided to MCC 130 to configure packet processing circuitry 140. The following is a JSON configuration file that can be transmitted from ACC 120 to MCC 130 to get capabilities of packet processing circuitry 140 and/or other circuitry in packet processing device 110. More particularly, the file can be used to specify a number of transmit queues, number of receive queues, number of supported traffic classes (tc), number of available interrupt vectors, number of available virtual ports and the types of the ports, size of allocated memory, supported parser profiles, exact match table profiles, packet mirroring profiles, among others.

```
@startjson LAN Data Path Capabilities
{
  “lan_datapath_caps”: {
    “_comment”: “LAN DataPath device level capabilities”,
    “vsi_resources”: {
      “vsi”: 200
    },
    “queue_resources”: {
      “tx_q”: 16,
      “tx_comp_q”: 1,
      “rx_q”: 16,
      “rx_buff_q”: 1
    },
    “qos_resources”: {
      “max_tc_num”: 4
    },
    “interrupt_resources”: {
      “vect_num”: 1
    },
    “vport_resources”: {
      “vport_total_num”: 1,
      “vport_sriov_num”: 1,
      “vport_siov_num”: 1,
      “vport_mng_num”: 1,
      “vport_subdev_num”: 1,
    },
    “fxp_device_resources”: {
      “fxp_backend_memory”: 1,
      “rss_tbl_size”: 33792
    },
    “counters_memory”: {
      “cntr_backend_memory”: 1,
    },
    “parser_resources”: {
      “parser_support”: 1,
      “sem_profile_num”: 1,
      “sem_obj_id_num”: 1,
      “mirror_profile_num”: 1
    }
  }
}
@endjson
```

The following is a JSON configuration file that can be transmitted from SDN controller 150 to ACC 120 to set policies applied by ACC 120. More particularly, the file can configure host resources policy, Adaptive Packet Filtering (APF) policy, Adaptive Virtual Function (AVF) resources policy, enable/disable priority flow control (PFC) per traffic class (TC), weights of traffic classes (TCs) for weighted fair queueing (wfq) arbitration, bandwidth (bw) allocation per TC, enable/disable priority flow control (PFC) per traffic class (TC), Traffic Shaper configurations, NVME Protocol Engine configurations, LCE Protocol Engine configurations, device capabilities such as checksum, receive side coalescing (RSC), remote direct memory access (RDMA), Single Root Input Output Virtualization (SRIOV) (e.g., Single Root I/O Virtualization (SR-IOV) and Sharing specification, version 1.1, published Jan. 20, 2010 by the Peripheral Component Interconnect (PCI) Special Interest Group (PCI-SIG) and variations thereof), media access control (MAC) address of a SRIOV physical function (PF), decides a number of virtual port per PF, number of transmit and receive queues, and others.

```
@startjson ACC_policy
{
  “host_resources”: {
    “host_0”: {
      “_comment”: “define host resources policy”,
      “func_caps”: {
        “csum” : false,
        “seg” : false,
        “rsc” : false,
        “hsplit” : false,
        “rdma” : false,
        “sriov” : false,
        “ipsec” : false,
        “ptp” : false
      },
      “pf”: {
        “_comment”: “define Adaptive Packet Filtering (APF) resources policy”,
        “mac_addr”: {
          “start” : “00:00:00:00:03:14”
        },
        “vport”: {
          “num” : 1
        },
        “vf” : {
          “vf_num”: 16
        },
        “tx_q”: {
          “num” : 16
        },
        “tx_comp_q”: {
          “num” : 1
        },
        “rx_q”: {
          “num” : 16
        },
        “rx_buff_q”: {
          “num” : 1
        },
        “vect_num”: {
          “num” : 1
        },
        “tx_q_region”: {
          “num” : 4
        },
        “rx_q_region”: {
          “num” : 4
        },
        “pir_rate_limit”: {
          “pps” : false,
          “value” : 512000
        },
        “vmrl”: {
          “num” : 5,
          “start_id” : 0
        },
        “rsc”: {
          “max_num” : 5
        }
      },
      “vf” : {
        “_comment”: “define Adaptive Virtual Function (AVF) resources policy”,
        “vport”: {
          “num” : 1
        },
        “vsi”: {
          “num” : 1
        },
        “tx_q”: {
          “num” : 8
        },
        “tx_comp_q”: {
          “num” : 1
        },
        “rx_q”: {
          “num” : 8
        },
        “rx_buff_q”: {
          “num” : 1
        },
        “vect_num”: {
          “num” : 1
        },
        “tx_q_region”: {
          “num” : 4
        },
        “rx_q_region”: {
          “num” : 4
        },
        “pir_rate_limit”: {
          “pps” : false,
          “value” : 512000
        },
        “vmrl”: {
          “id” : 5
        },
        “rsc”: {
          “max_num” : 5
        }
      },
      “tx_tc”: {
        “enable”: [
          true, false, false, false, false, false, false, false
        ],
        “_comment_prio”: “for weighted fair queueing (WFQ) arbitration, weights of TC”,
        “prio”: [
          0, 0, 0, 0, 0, 0, 0, 0
        ],
        “_comment_bw”: “bw allocation per traffic class (TC)”,
        “bw”: [
          100, 0, 0, 0, 0, 0, 0, 0
        ],
        “_comment_tsa”: “arbitration per TC - strict priority (SP)/WFQ”,
        “tsa”: [
          1, 0, 0, 0, 0, 0, 0, 0
        ],
        “_comment_pfc”: “enable/disable priority flow control (PFC) per traffic class (TC)”,
        “pfc_enable”: [
          0, 0, 0, 0, 0, 0, 0, 0
        ]
      },
      “manageability”: {
        “_comment”: “defines manageability for host”,
        “enable”: false,
        “vsi”: {
          “num” : 1
        },
        “tx_q”: {
          “num” : 1
        },
        “rx_q”: {
          “num” : 1
        }
      }
    }
  },
  “dev_caps”: {
    “_comment”: “device level capabilities”,
    “ts”: {
      “_comment”: “Traffic Shaper configurations”,
      “mode” : 1
    },
    “nvme”: {
      “_comment”: “NVME Protocol Engine configurations”,
      “tbd” : 1
    },
    “lce”: {
      “_comment”: “LCE Protocol Engine configurations”,
      “tbd” : 1
    }
  }
}
@endjson
```

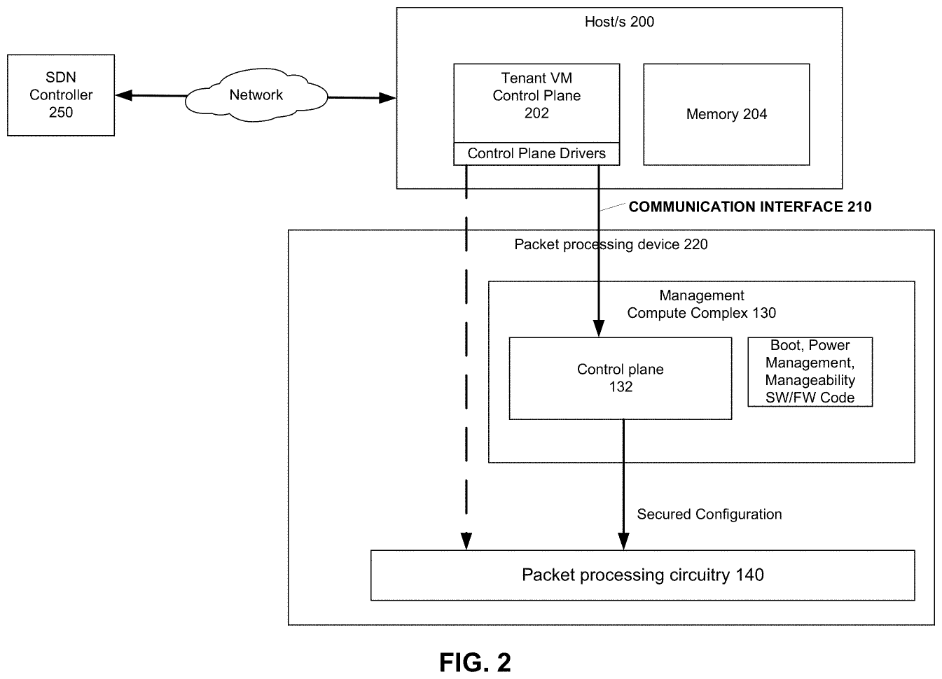

FIG. 2 depicts an example system. In some examples, ACC control plane (control plane 202) executes on host 200 as an application, virtual machine (VM), or other virtualized environment, instead of packet processing device 220. Host 200 can be implemented in a similar manner as that of host 100. Control plane 202 executing on host 200 can use communication interface 210 for communication between control plane 202 and control plane 132 executing on MCC 130. In a similar manner to communication interface 125, communication interface 210 can be used by host 200 to query about packet processing device 220 capabilities, configure operation of packet processing device 220, reserve device resources, and configure the packet processing circuitry 140 accelerations and indirect hardware register access, and perform other operations available through communication interface 125. Note that while a single host 200 is shown, multiple hosts can be used, where multiple hosts execute multiple ACC control planes that communicate using communication interfaces 210.

Communication interface 210 can include one or more mailboxes accessible as registers or memory addresses in memory 204 of host 200 and/or registers and/or memory in packet processing device 220. In other words, mailboxes can be allocated in registers or memory in host 200 alone, packet processing device 220 alone, or a combination of host 200 and packet processing device 220.

For communications from control plane 202 to control plane 132, communications can be written to the one or more mailboxes by control plane drivers executed by host 200. For communications from control plane 132 to control plane 120, communications can be written to the one or more mailboxes. To provide for secure communications between control plane 202 to control plane 132, registers and memory addresses (and memory address translations) for communications can be available only to be written to or read from by control plane 202 to control plane 132.

Communication interface 210 can be used for same software used across multiple and different deployments of packet processing devices. Different host and packet processing devices can use the same control plane software with provisioning adjusted for changes to platform software and/or hardware. Messages and descriptor formats can be similar to that utilized by communication interface 125.

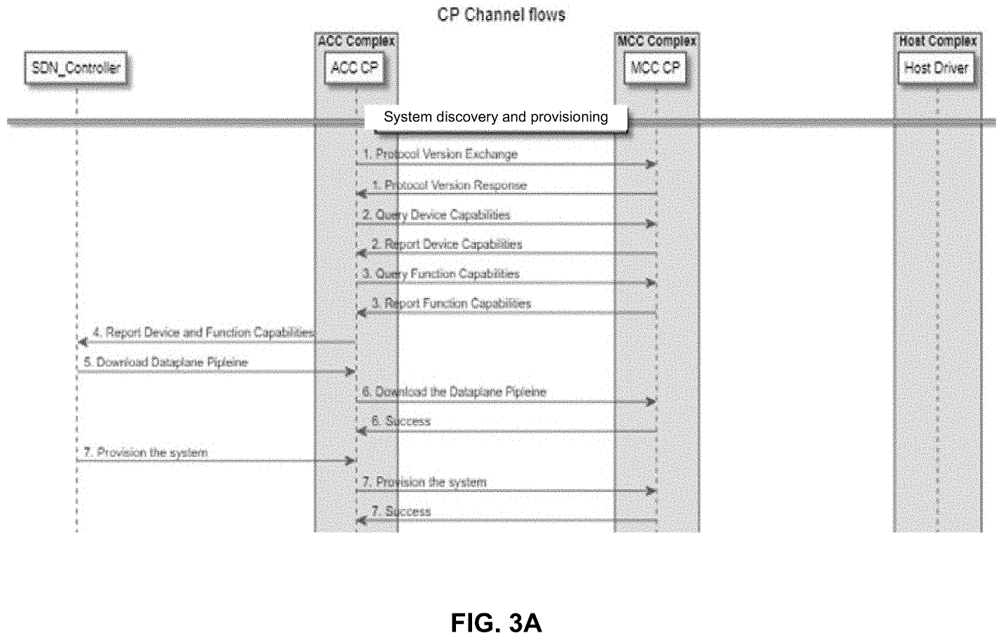

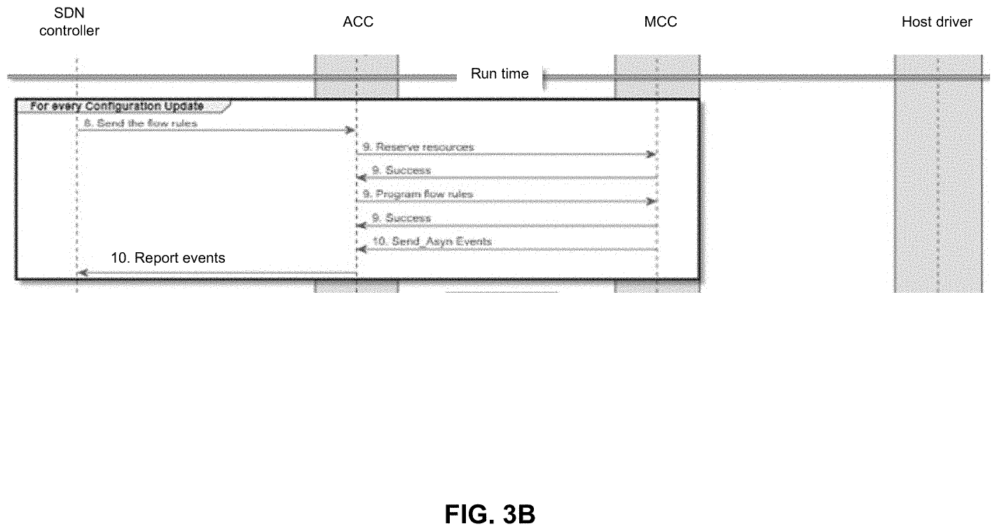

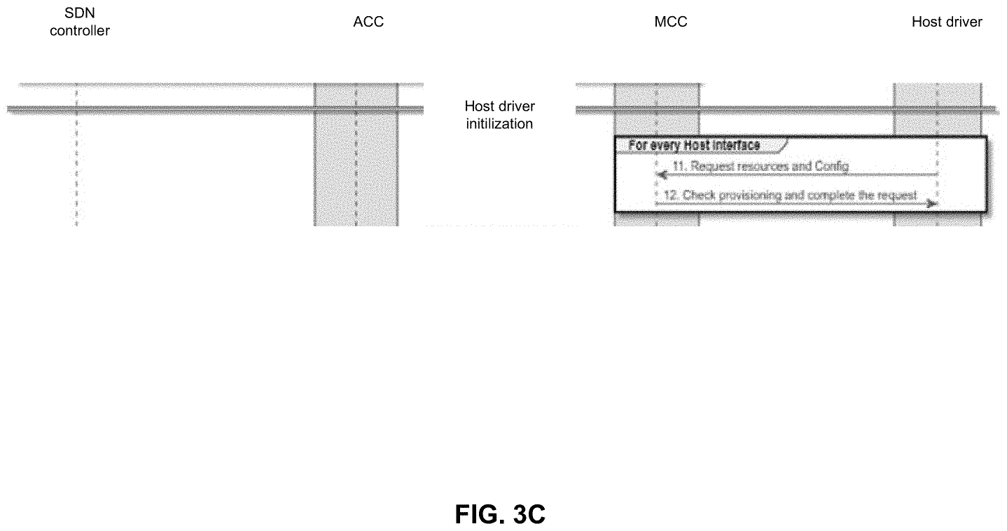

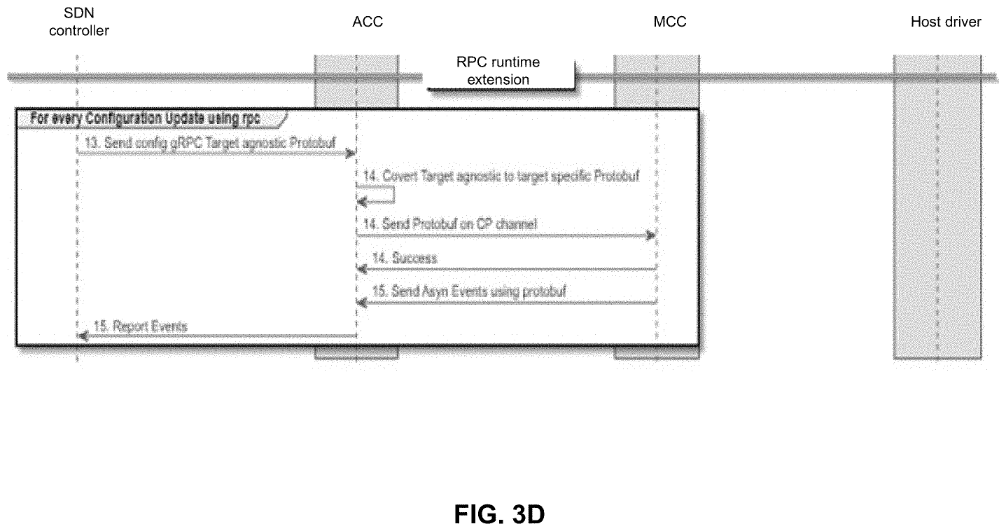

FIGS. 3A-3D depict an example configuration operation. A negotiation protocol and configuration protocol running between ACC and MCC which enables ACC control plane to configure and provision the device. In an initialization phase, one or more of actions (1) to (7) can be performed. At (1), the ACC control plane (CP) exchanges version messages with the MCC CP to negotiate version of CP channel (e.g., interface 125 or 210) to use. At (2), the ACC CP queries the MCC CP on the device capabilities and the MCC CP responds with the device capabilities and current device configuration. Examples of device capabilities are described herein.

At (3), the ACC CP queries the MCC CP on the function capabilities and the MCC CP responds with the function overall capabilities and current function configuration. At (4), the ACC CP reports to SDN controller provisioning capability of the system.

At (5), the SDN Controller sends the data plane pipeline configuration to the ACC CP. At (6), the ACC CP can use the communication interface to request MCC to configure the data plane and to download programmable data plane pipeline configuration. The data plane configuration can include configuration of parser, exact match table, wild card match, longest prefix match, packet mirroring, packet modifier, and others. At (7), the ACC control plane can change the device configuration and provisioning based on the device capabilities and node deployment request from SDN controller (e.g., compute node, storage node, etc.).

In a runtime phase, one or more of actions (8) to (10) can be performed. At (8), the SDN controller sends to the ACC CP runtime flow rules to configure the data plane. At (9), the ACC CP requests, from the MCC CP, runtime resources allocation such as flow rules and actions and configuration of the resources. The ACC CP requests to MCC CP to program the flow rules in programmable data plane pipeline. At (10), the same interface is used for event notification from the MCC CP to the DSN controller.

In a host driver initialization phase, one or more of actions (11) to (12) can be performed. At (11), after provisioning, a host driver executed by a host platform can request resources such as Transmit and Receive queues, interrupts, etcetera and configure these resources. At (12), the MCC CP can determine if the request was performed according to the provisioning downloaded from the ACC CP and indicate completion or non-completion of the request to the host driver.

One or more of actions (13) to (15) can be performed to extend CP channel to protobuf RPC use to configure the ACC during runtime. At (13), SDN Controller can send one or more gRPC target agnostic packets to the ACC CP. The content can include a request to configure a resource or request information. At (14), the ACC CP can convert the target agnostic request to target specific protobuf request and send the message in a protobuf in a CP channel message. At (15), the MCC CP can send asynchronous events to the ACC CP using the protobuf and the ACC CP can report these events to the SDN Controller.

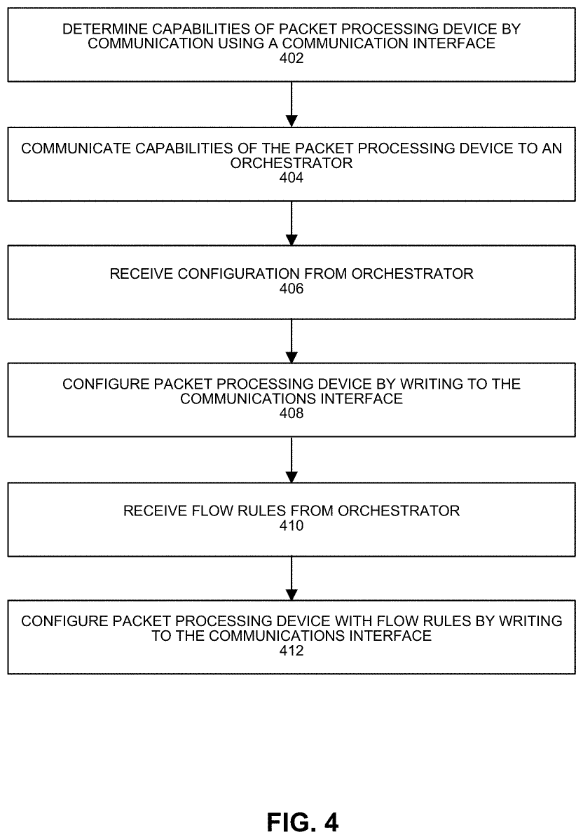

FIG. 4 depicts an example process. The process can be performed for communication between control planes executing in different compute complexes or platforms. At 402, a first control plane can determine capabilities of a packet processing device by communication with a second control plane using a communication interface (e.g., interface 125 or 210). For example, the first control plane can be executed by a compute complex or platform in a packet processing device. For example, the second control plane can be executed by a same or different compute complex or platform in the packet processing device. In some examples, capabilities of a packet processing device include capabilities of a programmable data plane and other circuitries. Examples of capabilities of a packet processing device can include one or more of: capability to issue non-volatile memory express (NVMe) read or write operations, address translation, compression or decompression, encryption or decryption, configuration as a storage node, configuration as a tenant hosting node, configuration as a compute node, device capabilities such as checksum, receive side coalescing (RSC), remote direct memory access (RDMA), Single Root Input Output Virtualization (SRIOV), media access control (MAC) address of a SRIOV physical function (PF), decides a number of virtual port per PF, number of transmit and receive queues, and others. The communication interface can be implemented using registers and/or memory regions with associated memory addresses that the first control plane can write to or read from and that the second control plane can write to or read from. At 404, the first control plane can communicate the determined capabilities of the packet processing device to an orchestrator.

At 406, the first control plane can receive a configuration from the orchestrator. For example, the orchestrator can include an SDN controller. For example, the configuration can include a data plane pipeline configuration. Data plane pipeline configuration can include parser, exact match table, wild card match, longest prefix match, packet mirroring, packet modifier, or others. Data plane pipeline configuration can include match action rules or other configuration file (e.g., P4 file or other file). At 408, the first control plane can change device configuration of the packet processing device by writing to the communication interface and based on the received configuration by requesting that the second control plane configure the packet processing device based on the received configuration.

At 410, the first control plane can receive runtime flow rules configurations from the orchestrator. At 412, the first control plane can change flow rules configurations of the packet processing device by writing to the communication interface and based on the received flow rules configurations. Examples of flow rules include exact match table rules, wild card match table rules, longest prefix match rules, or others.

FIG. 5 depicts an example packet processing device. In some examples, configuration of the packet processing device can be programmed using multiple control planes executing on one or more of processors 504 using a communication interface, as described herein. In some examples, packet processing device 500 can be implemented as a network interface controller, network interface card, a host fabric interface (HFI), or host bus adapter (HBA), and such examples can be interchangeable. Packet processing device 500 can be coupled to one or more servers using a bus, PCIe, CXL, or DDR. Packet processing device 500 may be embodied as part of a system-on-a-chip (SoC) that includes one or more processors, or included on a multichip package that also contains one or more processors.

Some examples of packet processing device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and bus interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values.

Processors 504 can be any a combination of a: processor, core, graphics processing unit (GPU), field programmable gate array (FPGA), application specific integrated circuit (ASIC), or other programmable hardware device that allow programming of network interface 500. For example, a “smart network interface” can provide packet processing capabilities in the network interface using processors 504.

Processors 504 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others. Processors 504 and/or system on chip 550 can execute instructions to configure and utilize one or more circuitry as well as check against violation against use configurations, as described herein.

Packet allocator 524 can provide distribution of received packets for processing by multiple CPUs or cores using timeslot allocation described herein or RSS. When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with PCI, PCI Express, PCI-x, Serial ATA, and/or USB compatible interface (although other interconnection standards may be used).

FIG. 6 depicts an example packet processing pipeline that can be used in a switch, network device, or packet processing device. A packet processing pipeline several ingress pipelines 620, a traffic management unit (referred to as a traffic manager) 650, and several egress pipelines 630. Though shown as separate structures, in some examples the ingress pipelines 620 and the egress pipelines 630 can use the same circuitry resources. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

Configuration of the packet processing pipeline by one or more control planes can take place via a communication interface, as described herein. Configuration of operation of packet processing pipelines, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

In some examples, in response to receiving a packet, the packet is directed to one of the ingress pipelines 620 where an ingress pipeline which may correspond to one or more ports of a hardware forwarding element. After passing through the selected ingress pipeline 620, the packet is sent to the traffic manager 650, where the packet is enqueued and placed in the output buffer 654. In some examples, the ingress pipeline 620 that processes the packet specifies into which queue the packet is to be placed by the traffic manager 650 (e.g., based on the destination of the packet or a flow identifier of the packet). The traffic manager 650 then dispatches the packet to the appropriate egress pipeline 630 where an egress pipeline may correspond to one or more ports of the forwarding element. In some examples, there is no necessary correlation between which of the ingress pipelines 620 processes a packet and to which of the egress pipelines 630 the traffic manager 650 dispatches the packet. That is, a packet might be initially processed by ingress pipeline 620b after receipt through a first port, and then subsequently by egress pipeline 630a to be sent out a second port, etc.

A least one ingress pipeline 620 includes a parser 622, plural match-action units (MAUs) 624, and a deparser 626. Similarly, egress pipeline 630 can include a parser 632, plural MAUs 634, and a deparser 636. The parser 622 or 632, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 622 or 632 separates out the packet headers (up to a designated point) from the payload of the packet, and sends the payload (or the entire packet, including the headers and payload) directly to the deparser without passing through the MAU processing.

MAUs 624 or 634 can perform processing on the packet data. In some examples, MAUs includes a sequence of stages, with a stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, MAU(s) can be used to determine whether to migrate data to another memory device and select another memory device, as described herein.

The deparser 626 or 636 can reconstruct the packet using a packet header vector (PHV) as modified by the MAU 624 or 634 and the payload received directly from the parser 622 or 632. The deparser can construct a packet that can be sent out over the physical network, or to the traffic manager 650. In some examples, the deparser can construct this packet based on data received along with the PHV that specifies the protocols to include in the packet header, as well as its own stored list of data container locations for possible protocol's header fields.

Traffic manager 650 can include a packet replicator 652 and output buffer 654. In some examples, the traffic manager 650 may include other components, such as a feedback generator for sending signals regarding output port failures, a series of queues and schedulers for these queues, queue state analysis components, as well as additional components. The packet replicator 652 of some examples performs replication for broadcast/multicast packets, generating multiple packets to be added to the output buffer (e.g., to be distributed to different egress pipelines).

The output buffer 654 can be part of a queuing and buffering system of the traffic manager in some examples. The traffic manager 650 can provide a shared buffer that accommodates any queuing delays in the egress pipelines. In some examples, this shared output buffer 654 can store packet data, while references (e.g., pointers) to that packet data are kept in different queues for egress pipeline 630. The egress pipelines can request their respective data from the common data buffer using a queuing policy that is control-plane configurable. When a packet data reference reaches the head of its queue and is scheduled for dequeuing, the corresponding packet data can be read out of the output buffer 654 and into the corresponding egress pipeline 630. In some examples, packet data may be referenced by multiple pipelines (e.g., for a multicast packet). In this case, the packet data is not removed from this output buffer 654 until references to the packet data have cleared their respective queues.

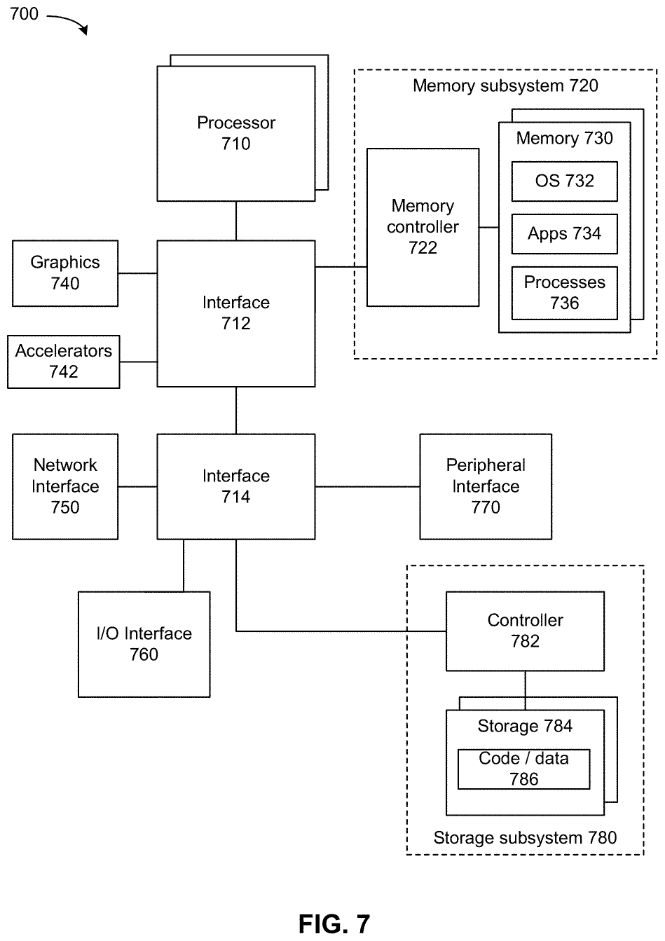

FIG. 7 depicts a system. In some examples, operation of programmable pipelines of network interface 750 can be programmed using multiple control planes executing on one or more processors (e.g., one or more of processor 710 or one or more processors in network interface 750) using a communication interface, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

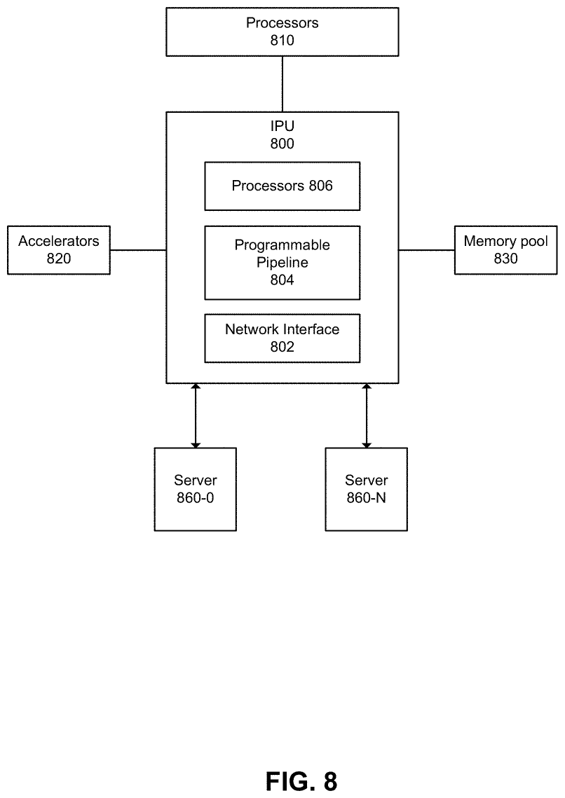

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, network interface 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 8.

In some examples, configuration of programmable pipelines of network interface 750 can be programmed using multiple control planes executing on one or more processors (e.g., one or more of processor 710 or one or more processors in network interface 750) using a communication interface, as described herein.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 700 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

FIG. 8 depicts an example system. In this system, IPU 800 manages performance of one or more processes using one or more of processors 806, processors 810, accelerators 820, memory pool 830, or servers 840-0 to 840-N, where N is an integer of 1 or more. In some examples, processors 806 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802.

In some examples, programmable pipelines 804 can be programmed using one or more control planes executing on one or more processors (e.g., one or more of processors 806) using a communication interface, as described herein

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a packet processing device comprising multiple processors and data plane circuitry, wherein a first processor of the multiple processors is to perform a first control plane, a second processor of the multiple processors is to perform a second control plane, and the first and second control planes are to communicate through an interface and wherein the first control plane is to discover capabilities of data plane circuitry and configure operation of the data plane circuitry by the interface.

Example 2 includes one or more examples, wherein the interface comprises a region in one or more of: one or more registers or one or more memory devices.

Example 3 includes one or more examples, wherein the second control plane is to configure the data plane circuitry to perform operations related to one or more of: non-volatile memory express (NVMe) read or write operations, address translation, compression or decompression, encryption or decryption, configuration as a storage node, configuration as a tenant hosting node, or configuration as a compute node.

Example 4 includes one or more examples, wherein the second control plane is to configure the data plane circuitry to perform match-action operations.

Example 5 includes one or more examples, wherein the first control plane is to configure the second control plane based on a configuration from a software defined networking (SDN) controller.

Example 6 includes one or more examples, wherein the first and second control planes are to communicate through an interface comprises the first control plane to communicate the second control plane one or more of: reserve hardware resources, receive hardware events, or perform hardware register reads or writes for debugging.

Example 7 includes one or more examples, wherein the interface is to perform an access control list (ACL) to limit communications to the first control plane and to second control plane.

Example 8 includes one or more examples, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 9 includes one or more examples, and includes a computer-readable medium comprising instructions stored thereon, that if executed by one or more processors, cause the one or more processors to: perform a first control plane that is to communicate through an interface with a second control plane for the first control plane to discover capabilities of data plane circuitry of a packet processing device and configure operation of the data plane circuitry.

Example 10 includes one or more examples, wherein the interface comprises an allocation in one or more of: one or more registers or one or more memory devices.

Example 11 includes one or more examples, wherein the second control plane is to configure the data plane circuitry to perform operations related to one or more of: non-volatile memory express (NVMe) read or write operations, address translation, compression or decompression, encryption or decryption, configuration as a storage node, configuration as a tenant hosting node, or configuration as a compute node.

Example 12 includes one or more examples, wherein the second control plane is to configure the data plane circuitry to perform match-action operations.

Example 13 includes one or more examples, wherein the first control plane is to configure the second control plane based on a configuration from a software defined networking (SDN) controller.

Example 14 includes one or more examples, wherein the first and second control planes are to communicate through an interface comprises the first control plane to communicate the second control plane one or more of: reserve hardware resources, receive hardware events, or perform hardware register reads or writes for debugging.

Example 15 includes one or more examples, wherein the interface is to perform an access control list (ACL) to limit communications to the first control plane and to second control plane.

Example 16 includes one or more examples, and includes a method comprising: performing a first control plane and performing a second control plane, wherein the first and second control planes are to communicate through an interface for the first control plane to discover capabilities of data plane circuitry and configure operation of the data plane circuitry.

Example 17 includes one or more examples, wherein the interface comprises an allocation in one or more of: one or more registers or one or more memory devices.

Example 18 includes one or more examples, wherein the second control plane configures operation of the data plane circuitry to perform operations related to one or more of: non-volatile memory express (NVMe) read or write operations, address translation, compression or decompression, encryption or decryption, configuration as a storage node, configuration as a tenant hosting node, or configuration as a compute node.

Example 19 includes one or more examples, wherein the second control plane configures the data plane circuitry to perform match-action operations.

Example 20 includes one or more examples, wherein the first control plane configures the second control plane based on a configuration from a software defined networking (SDN) controller.

What is claimed is:

1. An apparatus comprising:
a packet processing device comprising multiple processors and data plane circuitry, wherein
a first processor of the multiple processors is to perform a first control plane, a second processor of the multiple processors is to perform a second control plane, and the first and second control planes are to communicate through an interface and wherein the first control plane is to discover capabilities of data plane circuitry and configure operation of the data plane circuitry by the interface.

2. The apparatus of claim 1, wherein the interface comprises a region in one or more of: one or more registers or one or more memory devices.

3. The apparatus of claim 1, wherein the second control plane is to configure the data plane circuitry to perform operations related to one or more of: non-volatile memory express (NVMe) read or write operations, address translation, compression or decompression, encryption or decryption, configuration as a storage node, configuration as a tenant hosting node, or configuration as a compute node.

4. The apparatus of claim 1, wherein the second control plane is to configure the data plane circuitry to perform match-action operations.

5. The apparatus of claim 1, wherein the first control plane is to configure the second control plane based on a configuration from a software defined networking (SDN) controller.

6. The apparatus of claim 1, wherein the first and second control planes are to communicate through an interface comprises the first control plane to communicate the second control plane one or more of: reserve hardware resources, receive hardware events, or perform hardware register reads or writes for debugging.

7. The apparatus of claim 1, wherein the interface is to perform an access control list (ACL) to limit communications to the first control plane and to second control plane.

8. The apparatus of claim 1, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

9. A computer-readable medium comprising instructions stored thereon, that if executed by one or more processors, cause the one or more processors to:
perform a first control plane that is to communicate through an interface with a second control plane for the first control plane to discover capabilities of data plane circuitry of a packet processing device and configure operation of the data plane circuitry.

10. The computer-readable medium of claim 9, wherein the interface comprises an allocation in one or more of: one or more registers or one or more memory devices.

11. The computer-readable medium of claim 9, wherein the second control plane is to configure the data plane circuitry to perform operations related to one or more of: non-volatile memory express (NVMe) read or write operations, address translation, compression or decompression, encryption or decryption, configuration as a storage node, configuration as a tenant hosting node, or configuration as a compute node.

12. The computer-readable medium of claim 9, wherein the second control plane is to configure the data plane circuitry to perform match-action operations.

13. The computer-readable medium of claim 9, wherein the first control plane is to configure the second control plane based on a configuration from a software defined networking (SDN) controller.

14. The computer-readable medium of claim 9, wherein the first and second control planes are to communicate through an interface comprises the first control plane to communicate the second control plane one or more of: reserve hardware resources, receive hardware events, or perform hardware register reads or writes for debugging.

15. The computer-readable medium of claim 9, wherein the interface is to perform an access control list (ACL) to limit communications to the first control plane and to second control plane.

16. A method comprising:
performing a first control plane and
performing a second control plane, wherein the first and second control planes are to communicate through an interface for the first control plane to discover capabilities of data plane circuitry and configure operation of the data plane circuitry.

17. The method of claim 16, wherein the interface comprises an allocation in one or more of:
one or more registers or one or more memory devices.

18. The method of claim 16, wherein the second control plane configures operation of the data plane circuitry to perform operations related to one or more of: non-volatile memory express (NVMe) read or write operations, address translation, compression or decompression, encryption or decryption, configuration as a storage node, configuration as a tenant hosting node, or configuration as a compute node.

19. The method of claim 16, wherein the second control plane configures the data plane circuitry to perform match-action operations.

20. The method of claim 16, wherein the first control plane configures the second control plane based on a configuration from a software defined networking (SDN) controller.
